(19) United States
(12) Patent Application Publication
(10) Pub. No.: US 2024/0042320 A1
(43) Pub. Date: Feb. 8, 2024

(54) METHOD FOR DETERMINING ACTION OF BOT AUTOMATICALLY PLAYING CHAMPION WITHIN BATTLEFIELD OF LEAGUE OF LEGENDS GAME, AND COMPUTING SYSTEM FOR PERFORMING SAME

(71) Applicant: GGQ COMPANY INC., Seoul (KR)

(72) Inventors: Min Seo KIM, Seoul (KR); Yong Su LEE, Seoul (KR)

(21) Appl. No.: 18/480,565

(22) Filed: Oct. 4, 2023

Related U.S. Application Data
(63) Continuation of application No. PCT/KR2022/003286, filed on Mar. 8, 2022.

(30) Foreign Application Priority Data
Apr. 5, 2021 (KR) 10-2021-0043812

(51) Int. Cl. A63F 13/56; A63F 13/35; A63F 13/69; A63F 13/822; G06N 3/0464

(52) U.S. Cl. CPC A63F 13/56; A63F 13/35; A63F 13/69; A63F 13/822; G06N 3/0464

(57) ABSTRACT

A method for determining an action of a bot automatically playing a champion within a battlefield of League of Legends (LoL), and a computing system for performing same. The computing system comprising: an acquisition module for periodically acquiring observation data observable in the computer game at each predetermined observation unit time while a game is in progress in a battlefield of the computer game; an agent module for, when the acquisition module acquires observation data, determining an action that the bot is to execute, by using the acquired observation data and a predetermined policy network, wherein the policy network is a deep neural network that outputs a probability of each of multiple executable actions that the bot is able to execute; and a learning module for periodically learning the policy network at each predetermined learning unit time while a game is in progress in the battlefield.

### TECHNICAL FIELD

The present disclosure relates to a method for determining an action of a bot automatically playing a champion within a battlefield of League of Legends (LoL) which is a computer game for e-sports and a computing system performing the same.

### BACKGROUND

League of Legends, one of the most successful e-sports computer games to date, is a game in the AOS (or MOBA) genre from Riot Games, which is a real-time siege game in which a total of ten (10) players, divided into two camps, select their own champions and enter battlefields such as ‘Summoner's Rift’ to raise their levels and skills and to be equipped with items to strengthen their champions and destroy the opposing camp.

It currently has many users from all over the world, and is one of the most played PC games around the world, and as of 2016, the number of monthly players reached more than 100 million, and as of August 2019, the combined number of concurrent users at peak hours on servers around the world per day was more than 8 million. In addition, numerous E-sports competitions are being held, including the League of Legends World Championship, which holds the record for the largest number of viewers among E-sports competitions around the world, and regional leagues. It was also selected as an official demonstration sport at the 2018 Jakarta-Palembang Asian Games.

League of Legends is a game in which players are divided into two competing camps on one battlefield and play together, so there is a limitation that 10 players are required. If 10 players do not gather, the battlefield cannot start, and if one player leaves the battlefield while the game is in progress, there is a problem that the balance between teams suddenly falls. Therefore, in order to allow the game to start even if all 10 players are not together, or to maintain the balance between the two camps even if one player leaves the game that has already started, a bot that can automatically control the champion on behalf of a person is needed. Further, if a bot capable of playing above a certain level is developed, it could be used for practice to improve the skills of E-sports players, and it could also be helpful in analyzing the content of E-sports games more in-depth.

In addition, with recent hardware developments, deep learning, a field of machine learning, is developing very quickly. Deep learning is a method of training a deep neural network with large amounts of data, and a deep neural network refers to an artificial neural network consisting of several hidden layers between an input layer and an output layer. Due to these developments in deep learning, remarkable achievements have been made in fields such as computer vision and speech recognition, and attempts are currently being made to apply deep learning in various fields.

### PRIOR ART DOCUMENT

### Patent Document

PCT/IB 2017/056902

### SUMMARY

Unlike other sports, in the case of E-sports games such as League of Legends, objective data can be extracted and objective index modeling for players is possible. Therefore, it will be possible to automatically implement a bot by training an artificial intelligence model that determines the actions of the bot through the obtained data and indicators.

Therefore, the technical task to be achieved by the present disclosure is to provide a method and system that can improve the performance of a bot capable of automatically controlling League of Legends champions through deep learning.

### Technical Solutions

According to one aspect of the present disclosure, there is provided a computing system for determining an action of a bot automatically playing a champion within a battlefield of League of Legends (LoL) which is a computer game for e-sports, the computing system including: an acquisition module configured to acquire observation data observable in the computer game periodically at every predetermined observation unit time while a game is in progress in the battlefield of the computer game, an agent module configured to, when the acquisition module acquires the observation data, determine an action to be executed by the bot using the acquired observation data and a predetermined policy network, wherein the policy network is a deep neural network that outputs a probability of each of a plurality of executable actions that the bot is able to execute, and a training module configured to train the policy network periodically at every predetermined training unit time while the game is in progress in the battlefield, wherein the agent module is configured to, when observation data s(t) is acquired at a t-th observation unit time, preprocess the observation data s(t) to generate input data, acquire a probability of each of the plurality of executable actions that the champion played by the bot is able to execute by inputting the generated input data to the policy network, determine an action a(t) to be executed next by the champion played by the bot based on the probability of each of the plurality of executable actions, deliver the action a(t) to the bot so that the champion played by the bot executes the action a(t), calculate a reward value r(t) based on observation data s(t+1) acquired at the next unit observation time after the action a(t) is executed, and store training data including the observation data s(t), the action a(t), and the reward value r(t) in a buffer, and wherein the training module is configured to train the policy network using multiple batches including a predetermined number of most recently stored training data among the training data stored in the buffer.

In an embodiment, the acquisition module may be configured to acquire game unit data including: an observation value of each of champions, minions, structures, installations, and neutral monsters existing in the battlefield; and
the observation data including a screen image of the bot playing on the battlefield.

In an embodiment, the game unit data may include game server-provided data which is acquirable through an API provided by a game server of the computer game; and self-analysis data which is acquirable by analyzing data output by a game client of the bot.

In an embodiment, the agent module may be configured to, in order to preprocess the observation data s(t) to generate the input data, input the game server-provided data included in the observation data s(t) into a fully connected layer, input the self-analysis data included in the observation data s(t) into a network structure in which a fully connected layer and an activation layer are connected in series, input the screen image of the bot included in the observation data s(t) into a convolution layer, and generate the input data by encoding data output from each layer in a predetermined manner.

In an embodiment, the agent module may be configured to, in order to calculate the reward value r(t), based on the observation data s(t+1), calculate an item value of each of N predefined solo items and M predefined team items (here, N and M are integers of 2 or more, and each of the N solo items and M team items is given a predetermined reward weight), and calculate the reward value r(t) using [Equation 1] or [Equation 2] below, wherein psᵢ and pt are values given by [Equation 3] below, αⱼ is a reward coefficient of a jth solo item, pᵢⱼ is an item value of a jth solo item of an ith champion belonging to a friendly team, βⱼ is a reward weight of a jth team item, qⱼ is an item value of a jth team item of the friendly team, K is a total number of friendly champions, w is a team coefficient which is a real number satisfying 0<=w<=1, c is a real number satisfying 0<c<1, and T is a period coefficient which is a predetermined positive real number.

$$r ( t ) = ( 1 - w ) {\sum }_{i = 1}^{K} ( {ps}_{i} \times {c}^{t / T} ) + w \times \frac{pt \times {c}^{t / T}}{K} \qquad [ Equation 1 ]$$

$$r ( t ) = ( 1 - w ) {\sum }_{i = 1}^{K} ( {ps}_{i} \times {c}^{t / T} ) + w \times pt \times {c}^{t / T} \qquad [ Equation 2 ]$$

$${ps}_{i} = {\sum }_{j = 1}^{N} ( {α}_{j} \times {p}_{ij} ) \qquad [ Equation 3 ]$$

$$pt = {\sum }_{j = 1}^{M} ( {β}_{j} \times {q}_{j} )$$

In an embodiment, the computing system may be configured to, acquire, from a game server generating battlefield instances of the computer game in parallel, observation data corresponding to each of the plurality of battlefield instances, determine in parallel actions to be executed by bots playing on the plurality of battlefields, and train the policy network.

According to another aspect of the disclosure, there is provided a method for determining an action of a bot automatically playing a champion within a battlefield of League of Legends (LoL) which a computer game for e-sports, the method including: an acquisition operation of acquiring, by a computing system, observation data observable in the computer game periodically at every predetermined observation unit time while a game is in progress in the battlefield of the computer game; a control operation of, when the observation data is acquired in the acquisition operation, determining, by the computing system, an action to be executed by the bot using the acquired observation data and a predetermined policy network, wherein the policy network is a deep neural network that outputs a probability of each of a plurality of executable actions that the bot is able to execute; and a training operation of training, by the computing system, the policy network periodically at every predetermined training unit time while the game is in progress in the battlefield, wherein the control operation includes: when observation data s(t) is acquired at a t-th observation unit time, preprocessing the observation data s(t) to generate input data; acquiring a probability of each of the plurality of executable actions that the champion played by the bot is able to execute by inputting the generated input data to the policy network; determining an action a(t) to be executed next by the champion played by the bot based on the probability of each of the plurality of executable actions; delivering the action a(t) to the bot so that the champion played by the bot executes the action a(t); calculating a reward value r(t) based on observation data s(t+1) acquired at the next unit observation time after the action a(t) is executed; and storing training data including the observation data s(t), the action a(t), and the reward value r(t) in a buffer, and wherein the training operation includes training the policy network using multiple batches including a predetermined number of most recently stored training data among the training data stored in the buffer.

In an embodiment, the preprocessing of the observation data s(t) to generate the input data may include: inputting the game server-provided data included in the observation data s(t) into a fully connected layer; inputting the self-analysis data included in the observation data s(t) into a network structure in which a fully connected layer and an activation layer are connected in series; inputting the screen image of the bot included in the observation data s(t) into a convolution layer; and generating the input data by encoding data output from each layer in a predetermined manner.

In an embodiment, the calculating of the reward value r(t) may include: based on the observation data s(t+1), calculating an item value of each of N predefined solo items and M predefined team items (here, N and M are integers of 2 or more, and each of the N solo items and M team items is given a predetermined reward weight); and calculating the reward value r(t) using [Equation 1] or [Equation 2] below, wherein psᵢ and pt are values given by [Equation 3] below, αⱼ is a reward coefficient of a jth solo item, pᵢⱼ is an item value of a jth solo item of an ith champion belonging to a friendly team, βⱼ is a reward weight of a jth team item, qⱼ is an item value of a jth team item of the friendly team, K is a total number of friendly champions, w is a team coefficient which is a real number satisfying 0<=w<=1, c is a real number satisfying 0<c<1, and T is a period coefficient which is a predetermined positive real number.

$$r ( t ) = ( 1 - w ) {\sum }_{i = 1}^{K} ( {ps}_{i} \times {c}^{t / T} ) + w \times \frac{pt \times {c}^{t / T}}{K} \qquad [ Equation 1 ]$$

$$r ( t ) = ( 1 - w ) {\sum }_{i = 1}^{K} ( {ps}_{i} \times {c}^{t / T} ) + w \times pt \times {c}^{t / T} \qquad [ Equation 2 ]$$

$${ps}_{i} = {\sum }_{j = 1}^{N} ( {α}_{j} \times {p}_{ij} ) \qquad [ Equation 3 ]$$

$$pt = {\sum }_{j = 1}^{M} ( {β}_{j} \times {q}_{j} )$$

According to another aspect of the disclosure, there is provided a computer program installed in a data processing device and recorded on a non-transitory medium for performing the method described above.

According to another aspect of the disclosure, there is provided a non-transitory computer-readable recording medium on which a computer program for performing the method described above is recorded.

According to another aspect of the disclosure, there is provided a computing system including a processor and memory, wherein the memory is configured to, when performed by the processor, cause the computing system to perform the method described above.

### Advantageous Effects

According to an embodiment of the present disclosure, it is possible to provide a method and system for improving the performance of a bot that can automatically control League of Legends champions through deep learning.

In addition, through this, it is possible to solve the problem of the current E-sports game analysis, which is the inability to provide an optimal solution, and to provide systematic data-based user feedback.

While, in existing sports, such as soccer, it is possible to improve basic physical strength, including repeated section running, and train in repetitive set-piece situations, such repetitive training was very difficult in conventional e-sports. However, by using the present disclosure, there is an effect that it is possible to solve the problem that repetitive training is impossible due to the nature of e-sports, and it is possible to provide repetitive training situations by analyzing weak points for each user.

In addition, the present disclosure can provide a bot tailored to the play of a specific player, allowing for individually tailored analysis and can be used for systematic player development.

In addition, according to an embodiment of the present disclosure, game analysis or bot training can be analyzed without providing an API from an E-sports game operator (or game company), and therefore has the advantage of being applicable to all e-sports games.

### BRIEF DESCRIPTION OF DRAWINGS

In order to more fully understand the drawings cited in the detailed description of the present disclosure, a brief description of each drawing is provided.

FIG. 1 is a diagram illustrating an environment in which a method for determining an action of a bot is performed according to an embodiment of the present disclosure.

FIG. 2 is a flowchart illustrating a method for determining an action of a bot according to an embodiment of the present disclosure.

FIG. 3 is a flowchart illustrating an example of a specific process in operation S130 of FIG. 2.

FIG. 4 is a diagram illustrating an example of a process in which the computing system preprocesses observation data.

FIG. 5 is a diagram illustrating an example of a policy network according to an embodiment of the present disclosure.

FIG. 6 is a diagram illustrating an example of reward coefficients in table form.

FIG. 7 is a diagram illustrating a method for determining a reward coefficient in advance.

FIG. 8 is a diagram illustrating an experience compression method to reduce access to external memory according to an embodiment of the present disclosure.

FIG. 9 is a diagram illustrating a schematic configuration of a computing system performing a method for determining an action of a bot according to an embodiment of the present disclosure.

FIG. 10 is a diagram illustrating an example in which multiple simulators are driven in parallel.

### DETAILED DESCRIPTION OF EXEMPLARY EMBODIMENTS

Since the present disclosure may be modified variously and have various embodiments, specific embodiments will be illustrated in the drawings and described in detail in the detailed description. However, this is not intended to limit the present disclosure to specific embodiments, and it should be understood to include all modifications, equivalents and substitutes included in the spirit and scope of the present disclosure. In describing the present invention, if it is determined that a detailed description of related known technologies may obscure the gist of the present disclosure, the detailed description will be omitted.

Terms such as first and second may be used to describe various components, but the components should not be limited by the terms. The terms are used only for the purpose of distinguishing one component from another component.

The terms used in the present application are used only to describe a particular embodiment and are not intended to limit the present disclosure. Singular expressions include plural expressions unless the context clearly means otherwise.

In this specification, it should be understood that terms such as “include” or “have” are intended to designate the presence of features, numbers, steps, operations, components, parts, or combinations thereof described in the specification, but do not preclude the possibility of the presence or addition of one or more other features, numbers, steps, operations, components, parts, or combinations thereof.

Additionally, in this specification, when one component ‘transmits’ data to another component, this means that the component may transmit the data directly to the other component or transmit the data to the other component through at least one other component. Conversely, when one component ‘directly transmits’ data to another component, it means that the data is transmitted from the component to the other component without going through still other component.

Hereinafter, with reference to the accompanying drawings, the present disclosure will be described in detail centering on embodiments of the present disclosure. Like reference numerals in each figure indicate like members.

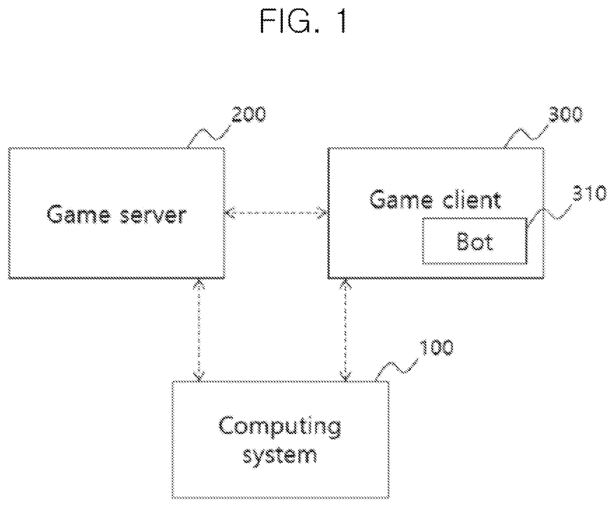

FIG. 1 is a diagram illustrating an environment in which a method for determining an action of a bot is performed according to an embodiment of the present disclosure.

Referring to FIG. 1, a computing system 100 may perform a method for determining the action of a bot that automatically plays a champion in a battlefield of a League of Legends game.

The League of Legends game may be played by a game server 200 and a game client 300. The game client 300 may have a League of Legends client program pre-installed, and can be connected to the game server 200 via the Internet to provide the League of Legends game to users.

Additionally, the AOS game simulator can replace the League of Legends client program for self-training efficiency. Since training with only the League of Legends client provided by Riot can be very difficult in reality, a self-developed AOS simulator may be needed to replace it.

In the case of the League of Legends game, the game is played in a way that several champions are divided into two teams and battle the opposing team or destroy structures of the opposing camp, and hereinafter, the space or map where structures of each camp are placed and each champion can operate will be referred to as the battlefield.

The game server 200 may be Riot's official game server, or may be a private server imitating the official server. The game server 200 may provide various information necessary for game play to the game client 300. When the game server 200 is a private server, the game server 200 may additionally provide various in-game data that is not provided by the official server.

The game server 200 may create a plurality of battlefield instances. An independent game may be played in each battlefield instance. The game server 200 may create the plurality of battlefield instances, so multiple League of Legends games may be played at the same time.

The game client 300 may include a bot 310. The bot 310 may automatically play champions in the battlefield of the League of Legends game on behalf of the user. The bot 310 may be application software that executes automated tasks.

The game client 300 may be an information processing device on which the League of Legends game program may be installed/run, and may include a personal computer such as a desktop computer, laptop computer, or notebook computer.

The computing system 100 may receive various information from the game server 200 and/or the game client 300 to determine what action the bot 310 will execute next, and by transmitting the determined action to the bot 310, the bot 310 may control the champion in the League of Legends battlefield to execute a predetermined action.

The computing system 100 may determine the action of the bot using a deep neural network that is trained in real time while the League of Legends game is played, which will be described later.

The computing system 100 may be connected to the game server 200 and the game client 300 through a wired/wireless network (e.g., the Internet) to transmit and receive various information, data and/or signals necessary to implement the technical idea of the present disclosure.

In an embodiment, the computing system 100 may acquire information necessary to implement the technical idea of the present disclosure through an application programming interface (API) provided by the game server 200.

Meanwhile, in case of FIG. 1, an example is shown in which the computing system 100 is physically separated from the game server 200 and the game client 300, but depending on the embodiment, the computing system 100 may be divided into a form included in the game server 200 or the game client 200.

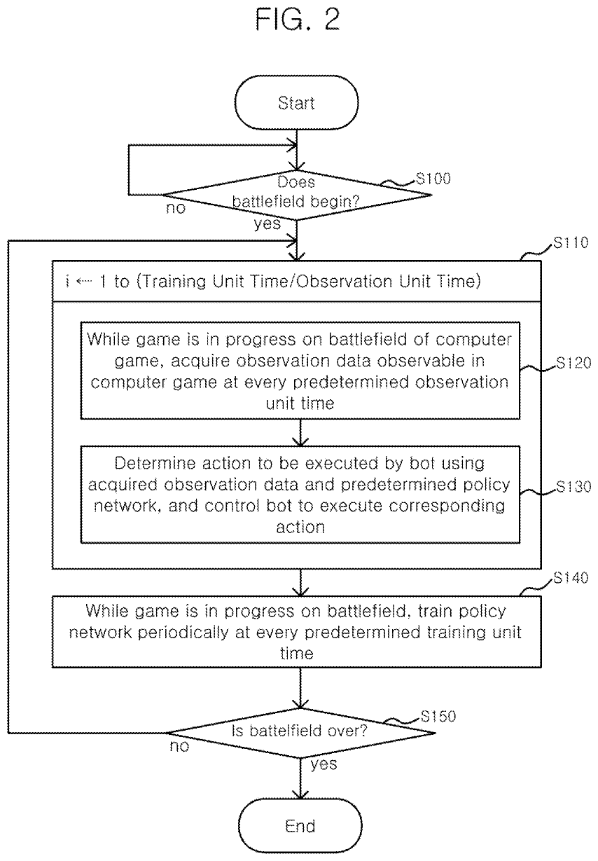

FIG. 2 is a flowchart illustrating a method for determining an action of a bot according to an embodiment of the present disclosure. Referring to FIG. 2, the method for determining the action of the bot may be performed from the beginning to the end of the battlefield of the League of Legends game (hereinafter referred to as a ‘computer game’) (see S100 and S150).

When a new battlefield is created and all players enter the battlefield and the battlefield begins (S100), the computing system 100 may acquire observation data observable in the computer game at each observation unit time (S120). For example, the computing system may acquire observation data every predetermined time (e.g., every 0.1 second) or a predetermined number of frames (e.g., every 3 frames). Preferably, the observation unit time may be preset to a level similar to the reaction speed of a typical player.

The observation data may include information about the battle status of both teams playing on the battlefield and game unit data, which is information indicating the current state of various objects existing on the battlefield, and the objects on the battlefield include user-playable champions, minions that automatically execute certain actions within the game even if they are not playable, various structures on the battlefield (e.g., turrets, suppressors, nexus, etc.), installations installed by champions (e.g., wards), neutral monsters, projectiles fired by other objects, etc.

Information indicating the current state of the object may include, for example, if the object is a champion, the object's ID, level, maximum HP, current HP, maximum MP, current MP, amount (or rate) of health regenerated, amount (or rate) of mana regenerated, various buffs and/or debuffs, status ailments (e.g., crowd control), armor, etc., and may further include information indicating the current location of the object (e.g., coordinates, etc.), the direction in which the object is looking, the moving speed, the currently targeting object, the item being worn, information about the action the champion is currently executing, information about skill status (e.g., availability, maximum cooldown, current cooldown), time elapsed since the start of the game, etc.

Meanwhile, in an embodiment, the game unit data may include game server-provided data that may be acquired through an API provided by the game server 200 of the computer game and/or self-analysis data that may be acquired by analyzing data output by the game client 300 of the bot 310.

More specifically, observation data used in the bot action determination method according to an embodiment of the present disclosure consists of various types of data, some of which may be acquired through an API provided by the game server 200. However, if data that cannot be acquired from the game server 200 is required, the computing system 100 may acquire corresponding data by analyzing information that may be acquired by the game client 300 or information 300 output by the game client. For example, the computing system 100 may acquire some of the observation data by analyzing a screen image that is being displayed or has already been displayed on the game client 300 and performing image-based object detection. Alternatively, the computing system 300 may control the game client 300 to perform a replay of a previously played game and acquire some of the observation data from the replayed game.

Depending on the embodiment, the observation data may further include a game screen image of the bot 310 playing on the battlefield. In this case, the computing system 100 may receive the game screen image displayed on the game client 300 from the game client 300.

Referring again to FIG. 2, when the observation data is acquired, the computing system 100 may determine an action to be executed by the bot 310 using the acquired observation data and a predetermined policy network, and may control the bot 310 to execute the action (S130).

The policy network may be a deep neural network that outputs the probability of each of a plurality of executable actions that the bot 310 may execute.

The plurality of executable actions may be individual elements included in an action space, which is a predefined set. The plurality of executable actions may include, for example, staying, moving to a specific point, attacking, one or more non-targeting skills without a specific target, one or more point-targeting skills that target a specific point, one or more unit-targeting skills that target a specific unit, and one or more offset-targeting skills that are used by specifying a specific point or direction rather than specifying a unit. For specific actions, parameter values may be required to fully define the action. For example, in the case of a moving action, there must be parameter data to express the specific point to move to, and in the case of a skill that heals a specific unit, there must be parameter data that may express the unit to be healed.

The policy network may be an artificial neural network. In this specification, the artificial neural network includes a multi-layer perceptron model and may refer to a set of information expressing a series of design details defining the artificial neural network. As is well known, the artificial neural network may include an input layer, a plurality of hidden layers, and an output layer.

Training of an artificial neural network may refer to a process in which the weight factors of each layer are determined. And when the artificial neural network is trained, the trained artificial neural network may receive input data in the input layer and output output data through a predefined output layer. The neural network according to an embodiment of the present disclosure may be defined by selecting one or a plurality of widely known design details, or unique design details may be defined for the neural network.

In an embodiment, the hidden layer included in the policy neural network may include at least one long short-term memory (LSTM) layer. The LSTM layer is a type of recurrent neural network and is a network structure with feedback connections.

Referring again to FIG. 2, the computing system 100 may periodically train the policy network at predetermined training unit times while the game is in progress on the battlefield (S140).

To this end, the computing system 100 may repeat operations S120 and S130 multiple times, and training data for training the policy network may be generated each time operations S120 and S130 are performed. The computing system 100 may generate training data by performing operations S120 and S130 for (training unit time/observation unit time) and the computing system 100 may train the policy network using the generated training data (S140).

For example, when the observation unit time is 0.1 seconds and the training unit time is 1 minute, the computing system 100 may perform operations S120 and S130 100 (=60/0.1) times to generate 600 training data, and then use this to train the policy network based on data from the past minute.

In an embodiment, the policy network may be trained using a policy gradient method, and the weight of each node constituting the policy network may be updated while training is in progress.

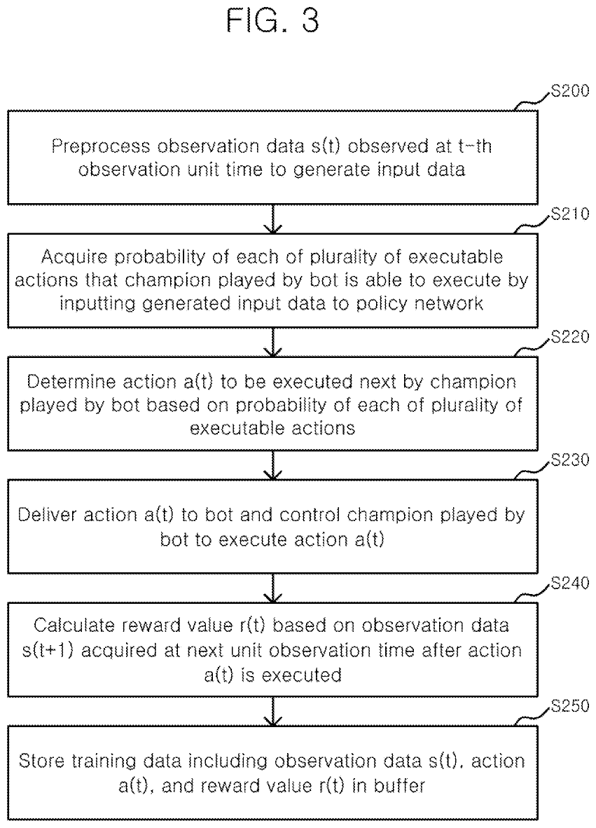

FIG. 3 is a flowchart illustrating an example of a specific process in operation S130 of FIG. 2. FIG. 3 shows the process after observation data s(t) is acquired at the t-th observation unit time.

Referring to FIG. 3, the computing system 100 may generate input data by preprocessing observation data s(t) observed at the t-th observation unit time (S200).

The computing system 100 is suitable for inputting observation data s(t) to a policy network, and may generate input data by preprocessing into a form that allows the policy network to produce as high a performance as possible.

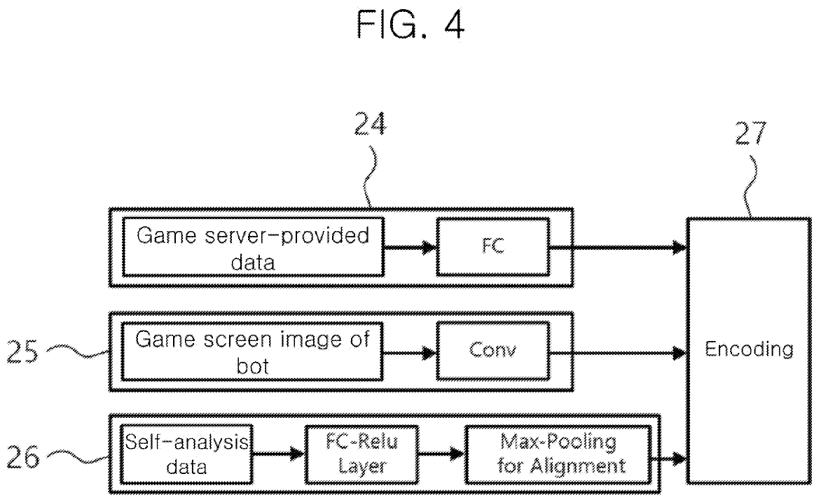

FIG. 4 is a diagram illustrating an example of a process in which the computing system 100 preprocesses observation data.

Referring to FIG. 4, the computing system 100 may input game server-provided data included in the observation data s(t) to a fully connected layer (24).

In addition, the computing system 100 may input self-analysis data included in the observation data s(t) into a network structure in which a fully connected layer and an activation layer are connected in series (26).

In addition, the computing system 100 may input the screen image of the bot included in the observation data s(t) into a convolution layer (S25). The reason for inputting into a convolution layer, unlike other data, is because the convolution layer preserves the positional relationship of each pixel in the image.

Thereafter, the computing system 100 may generate the input data by encoding the data output from each layer in a predetermined manner. At this time, the encoding may be an encoding method that does not cause data loss, and for example, it may be an encoding method that combines each data.

Referring again to FIG. 3, the computing system 100 may input the generated input data into the policy network to acquire the probability of each of the plurality of executable actions that the champion played by the bot may execute (S210).

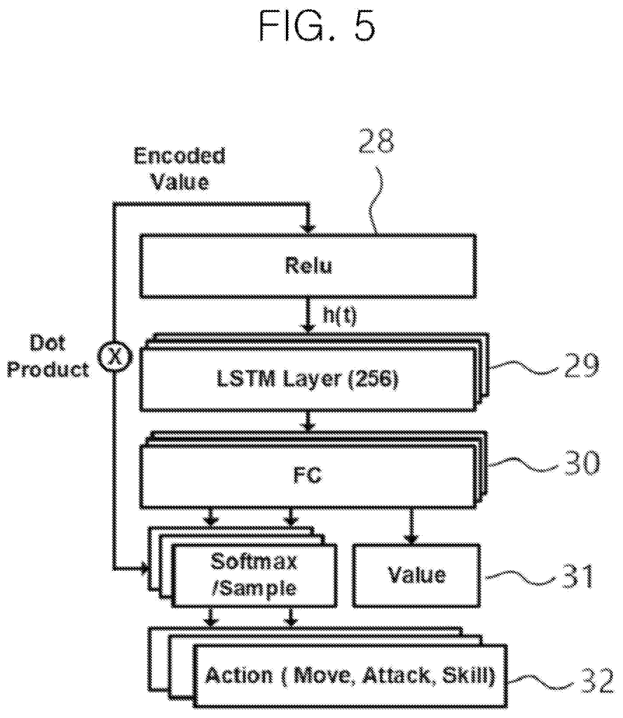

FIG. 5 is a diagram illustrating an example of a policy network according to an embodiment of the present disclosure. Referring to FIG. 5, the encoded input data is input as an input value to the policy network, which is a deep neural network, and the value is first received from the LSTM layer. The LSTM layer consists of a total of 256 layers, and the output value is assigned as the input value of the fully connected layer. The output value of the FC layer is used to extract the Value value and to determine the final action value through the softmax and sample operations.

In FIG. 5, the Relu Function layer 28 is a layer that preprocesses encoded values to receive them as input of the LSTM layer, the LSTM layer 29 is a layer that performs LSTM processing operation to maximize temporal information, and the fully connected layer 30 is a fully-connected layer for predicting action values with LSTM result values. Meanwhile, in the value 31 layer, a Value value generation process for policy network update is performed, and in the Action layer 32, the probability for each action value is generated after passing through the activation function.

Referring again to FIG. 3, the computing system 100 may determine the action a(t) to be executed next by the champion played by the bot based on the probability of each of the plurality of executable actions (S220). In other words, through operation S210, the probability distribution for the action space including the plurality of executable actions is determined, and the computing system 100 may determine the action a(t) to be executed next by the champion played by the bot based on this probability distribution.

Thereafter, the computing system 100 may deliver action a(t) to the bot and control the champion played by the bot to execute the action a(t) (S230).

Meanwhile, the computing system 100 may calculate the reward value r(t) based on observation data s(t+1) acquired at the next unit observation time after action a(t) is executed (S240). In other words, the computing system 100 may determine the reward value r(t) of action a(t) based on observation data s(t+1) acquired at the next unit observation time, which is the result of the action executed by the bot, and this reward value r(t) may be used to train the policy network later.

In an embodiment, the reward value r(t) may be calculated through [Equation 1] or [Equation 2] below.

$$r ( t ) = ( 1 - w ) {\sum }_{i = 1}^{K} ( {ps}_{i} \times {c}^{t / T} ) + w \times \frac{pt \times {c}^{t / T}}{K} \qquad [ Equation 1 ]$$

$$r ( t ) = ( 1 - w ) {\sum }_{i = 1}^{K} ( {ps}_{i} \times {c}^{t / T} ) + w \times pt \times {c}^{t / T} \qquad [ Equation 2 ]$$

Here, K is the total number of friendly champions (usually 5), w is a team coefficient which is a real number of 0<=w<=1, c is a predetermined real number of 0<c<1, T is a period coefficient which is a predetermined positive real number. The team coefficient w, is a variable value that gives weight to the reward value as the entire team, not the reward of each player, and c^{t/T} is a value for adjusting the reward value according to the elapsed time, and is obtained by applying the elapsed time t as an exponent to the constant value c.

Meanwhile, psᵢ and pt may be values given by [Equation 3] below. Here, αⱼ is the reward coefficient of the jth solo item, pᵢⱼ is the item value of the jth solo item of the ith champion belonging to the friendly team, βⱼ is the reward weight of the jth team item, and qⱼ is the item value of the jth team item of the friendly team.

$${ps}_{i} = {\sum }_{j = 1}^{N} ( {α}_{j} \times {p}_{ij} ) \qquad [ Equation 3 ]$$

$$pt = {\sum }_{j = 1}^{M} ( {β}_{j} \times {q}_{j} )$$

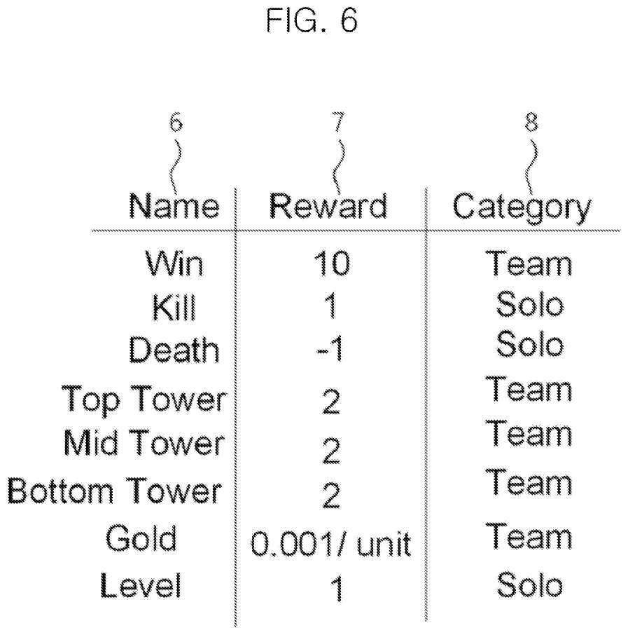

FIG. 6 is a diagram illustrating an example of reward coefficients in table form.

In FIG. 6, the category is a field that distinguishes whether the item is a team item or a solo item, the name indicates the name of the item, and the reward field indicates the reward coefficient of the item. In the case of items such as Gold, it is expressed as points per unit.

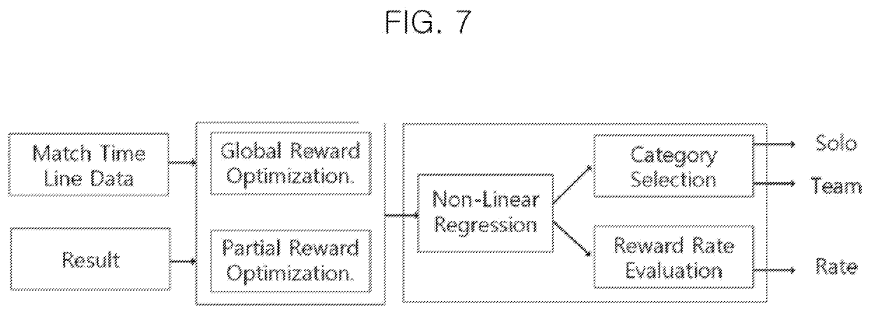

Meanwhile, the reward coefficient and category of each item as shown in FIG. 6 are predetermined, and in an embodiment of the present disclosure, the process of determining the optimal reward coefficient may be done in advance using previously played data and game results, and FIG. 7 is a diagram illustrating a method for determining a reward coefficient in advance.

Referring to FIG. 7, each data is optimized for the global reward coefficient value and the partial reward coefficient value, and non-linear regression is used to separate team variables and player variables and extract each optimized reward value.

The match line time data in FIG. 7 is the result data (champion by line, win rate by champion, win rate by time period, win rate by object) of League of Legends solo rank games, and Result is the result (actions for each observation unit time, reward values) in the current simulator environment. Global Reward Optimization refers to the process of classifying into factors that significantly affect the win rate in the entire game among given input values, and Partial Reward Optimization refers to the process of classifying into factors that significantly affect the short-term engagement win rate among given input values. Non-linear Regression refers to the process of dividing given input values into categories (team, solo) using a non-linear regression method and generating a reward coefficient (rate).

Referring again to FIG. 3, the computing system 100 may store training data consisting of observation data s(t), action a(t), and reward value r(t) in a buffer (S250). The training data stored in the buffer may later be used for training of the policy network.

Here, the buffer may be implemented as a memory device of the computing system 100. The buffer may function like a type of cache memory. In other words, the buffer may maintain the most recently input data or the most frequently used data.

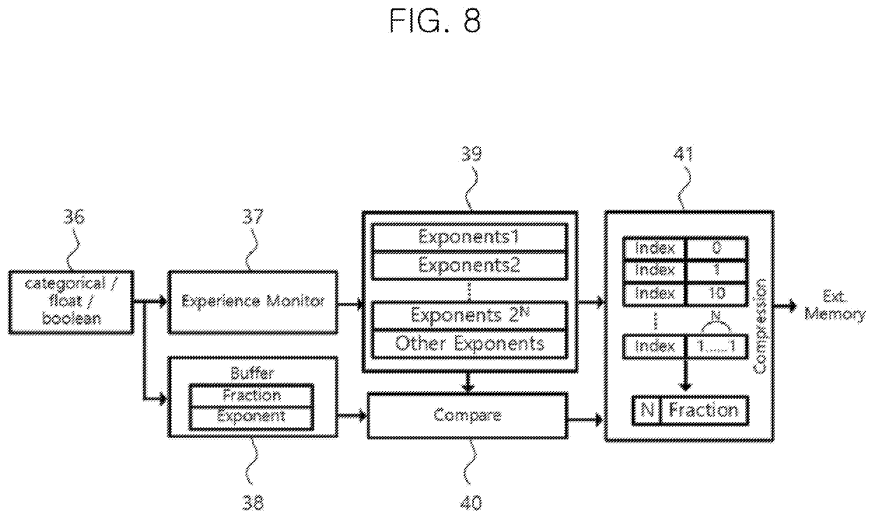

FIG. 8 is a diagram illustrating an experience compression method to reduce access to external memory according to an embodiment of the present disclosure.

First of all, the most important thing is to minimize access to external memory, which is the biggest factor in slowing down speed. First, the input status values 36 are stored in the experience monitor 37 and the register 38 that stores recent input values, respectively. At this time, the exponent values of each input value are monitored in experience monitor, and the N most frequently occurring input values 39 among the exponent values are separated according to index classification compressed at a ratio of 2^{N} 40. At this time, the input value and pre-sorted exponent values are compared, and matching values among the stored indices are sent to external memory 41.

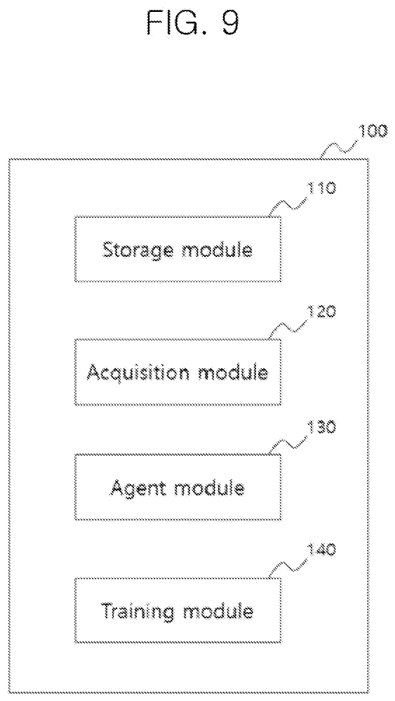

FIG. 9 is a diagram illustrating a schematic configuration of a computing system 100 performing a method for determining an action of a bot according to an embodiment of the present disclosure. In this specification, depending on the case, a computing system that performs a bot action determination method according to the technical idea of the present disclosure may be referred to as a bot acction determination system.

The computing system 100 may be a computing system that is a data processing device with computing capabilities to implement the technical idea of the present disclosure, and in general, it may include computing devices such as personal computers and mobile terminals as well as servers, which are data processing devices that may be accessed by clients through a network.

While the computing system 100 may be implemented as any one physical device, an average expert in the technical field of the present disclosure may easily infer that a plurality of physical devices may be organically combined as needed to implement the computing system 100 according to the technical idea of the present disclosure.

Referring to FIG. 9, the computing system 100 may include a storage module 110, an acquisition module 120, an agent module 130, and a training module 140. Depending on the embodiment of the present disclosure, some of the above-described components may not necessarily correspond to components essential for implementation of the present disclosure, and also, depending on the embodiment, the computing system 100 may include more components than these. For example, the system 100 may further include a control module (not shown) for controlling functions and/or resources of other components (e.g., storage module 110, acquisition module 120, agent module 130, training module 140, etc.) of the computing system 100. Alternatively, the computing system 100 may further include a communication module (not shown) for communicating with an external device through a network or an input/output module (not shown) for interacting with a user.

The computing system 100 may refer to a logical configuration equipped with hardware resources and/or software necessary to implement the technical idea of the present disclosure, and does not necessarily mean one physical component or one device. In other words, the system 100 may mean a logical combination of hardware and/or software provided to implement the technical idea of the present disclosure, and if necessary, may be implemented as a set of logical components to implement the technical idea of the present disclosure by being installed in devices separated from each other and performing each function. In addition, the system 100 may refer to a set of components implemented separately for each function or role to implement the technical idea of the present disclosure. For example, the storage module 110, acquisition module 120, agent module 130, and training module 140 may each be located in different physical devices or may be located in the same physical device. In addition, depending on the implementation example, the combination of software and/or hardware constituting each of the storage module 110, acquisition module 120, agent module 130, and training module 140 may be also located in different physical devices, and the components located in different physical devices may be organically combined to implement each of the modules.

In addition, in this specification, a module may mean a functional and structural combination of hardware for carrying out the technical idea of the present disclosure and software for driving the hardware. For example, it may be easily inferred by an average expert in the technical field of the present disclosure that the module may mean a logical unit of predetermined code and hardware resources for executing the predetermined code, and does not necessarily mean a physically connected code or a single type of hardware

The storage module 110 nay store various data necessary to implement the technical idea of the present disclosure. For example, the storage module 110 may store a policy network, which will be described later, or training data used to train the policy network.

The acquisition module 120 may periodically acquire observation data that may be observed in the computer game every predetermined observation unit time while the game is in progress on the battlefield of the computer game.

When the acquisition module 120 acquires observation data, the agent module 130 may determine an action to be executed by the bot using the acquired observation data and a predetermined policy network. At this time, the policy network may be a deep neural network that outputs the probability of each of a plurality executable actions that the bot can execute.

The training module 140 may periodically train the policy network at predetermined training unit times while the game is in progress on the battlefield.

Meanwhile, the agent module may be configured to, when observation data s(t) is acquired at the t-th observation unit time, preprocess the observation data s(t) to generate input data, acquire a probability of each of the plurality of executable actions that the champion played by the bot is able to execute by inputting the generated input data to the policy network, determine the action a(t) to be executed next by the champion played by the bot based on the probability of each of the plurality of executable actions, deliver the action a(t) to the bot so that the champion played by the bot executes the action a(t), calculate the reward value r(t) based on observation data s(t+1) acquired at the next unit observation time after the action a(t) is executed, and store training data including the observation data s(t), the action a(t), and the reward value r(t) in the buffer.

The training module may be configured to train the policy network using multiple batches including a predetermined number of most recently stored training data among the training data stored in the buffer.

In an embodiment, the acquisition module 120 may be configured to acquire game unit data including each observation value of champions, minions, structures, installations, and neutral monsters existing in the battlefield and the observation data including a screen image of the bot playing on the battlefield.

In an embodiment, the game unit data may include game server-provided data that may be acquired through an API provided by the game server 200 of the computer game and self-analysis data that may be acquired by analyzing data output by the game client of the bot.

In an embodiment, the agent module 130 may be configured to, in order to preprocess the observation data s(t) to generate input data, input the game server-provided data included in the observation data s(t) into a fully connected layer, input the self-analysis data included in the observation data s(t) into a network structure in which a fully connected layer and an activation layer are connected in series, input the screen image of the bot included in the observation data s(t) into a convolution layer, and generate the input data by encoding data output from each layer in a predetermined manner.

In an embodiment, the agent module may be configured to, in order to calculate the reward value r(t), based on the observation data s(t+1), calculate item values of each of N predefined solo items and M predefined team items (here, N and M are integers of 2 or more, and each of the N solo items and M team items is given a predetermined reward weight), and calculate the reward value r(t) using [Equation 4] or [Equation 5] below, wherein psᵢ and pt are values given by [Equation 6] below, αⱼ is a reward coefficient of the jth solo item, pᵢⱼ is the item value of a jth solo item of the ith champion belonging to a friendly team, βⱼ is a reward weight of the jth team item, qⱼ is the item value of the jth team item of the friendly team, K is a total number of friendly champions, w is a team coefficient which is a real number of 0<=w<=1, c is a real number of 0<c<1, and T is a period coefficient which is a predetermined positive real number.

$$r ( t ) = ( 1 - w ) {\sum }_{i = 1}^{K} ( {ps}_{i} \times {c}^{t / T} ) + w \times \frac{pt \times {c}^{t / T}}{K} \qquad [ Equation 4 ]$$

$$r ( t ) = ( 1 - w ) {\sum }_{i = 1}^{K} ( {ps}_{i} \times {c}^{t / T} ) + w \times pt \times {c}^{t / T} \qquad [ Equation 5 ]$$

$${ps}_{i} = {\sum }_{j = 1}^{N} ( {α}_{j} \times {p}_{ij} ) \qquad [ Equation 6 ]$$

$$pt = {\sum }_{j = 1}^{M} ( {β}_{j} \times {q}_{j} )$$

Meanwhile, as described above, according to an embodiment of the present disclosure, the game server 200 may create a plurality of battlefield instances of the League of Legends game, and game play may proceed on multiple battlefields at the same time, and the computing system 100 is capable of controlling the actions of each bot performing game play within multiple battlefield instances taking place simultaneously, and may train the policy network using all observation data that may be acquired from multiple battlefield instances. More specifically, the computing system 100 may create multiple simulators, and each simulator may perform operation S120 (acquiring observation data) and operation S130 (determining an action to be executed by the bot using the acquired observation data and policy network) of FIG. 2. Multiple training data acquired from simulators driven in parallel may be used to train one or multiple policy networks.

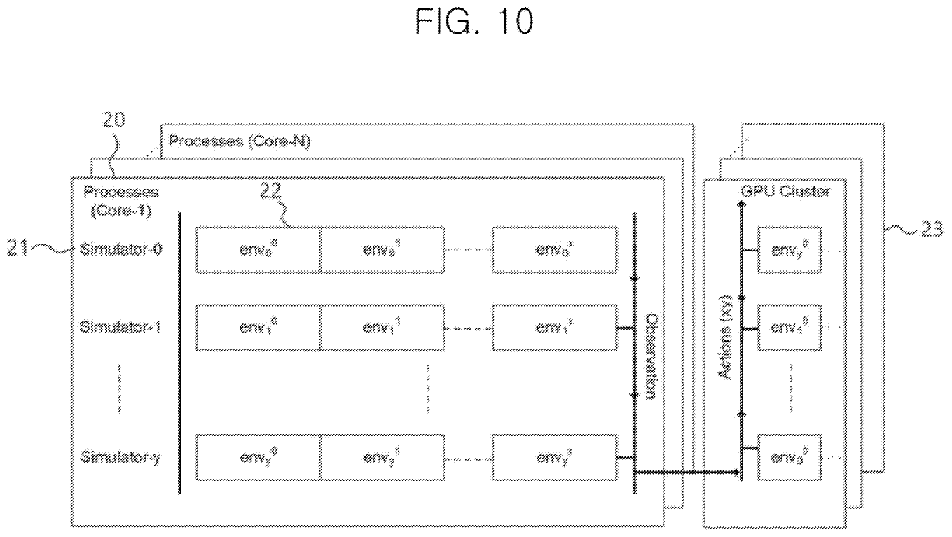

FIG. 10 is a diagram illustrating an example in which multiple simulators are driven in parallel. Referring to FIG. 10, synchronized sampling may be applied for parallelization of the bot action control method. In this case, multiple CPU cores may be linked to one GPU.

First, performing parallelization of simulator computations by allocating one simulator per CPU core to in the simplest structure may be assumed. In this case, the observation values of all individual simulators in each computation operation are combined into a batch sample for action value inference, and may later be called and performed on the GPU after all observations are completed. Each simulator determines one action value and then moves on to the next operation. To do this efficiently, the entire system may be designed to use shared-memory arrays for efficient and fast communication between the simulation process and the action-server.

Meanwhile, in order to solve the delay effect (the problem of the overall time being determined by the slowest processor), which is the biggest problem of synchronized sampling, the delay effect may be alleviated by applying a method of allocating multiple independent simulators to each CPU core, and the architecture for this is shown in FIG. 10.

The architecture for parallel processing in FIG. 10 may include multiple CPU cores 20 for computational processing, a simulator 21 assigned to each CPU core, and a GPU cluster 23 that calculates action values through a neural network inference process. Meanwhile, env0, env1, . . . env y 22 shown in FIG. 10 represent separate game environments. Here, the game environment may refer to a set containing all observable data in each corresponding battlefield instance. In this way, the policy network may be trained repeatedly through data collected from multiple game environments that are played simultaneously, enabling more efficient training.

Referring to FIG. 10, in each CPU core, all assigned simulators are serially updated using hyperthreading, and this is used for every inference batch. Further, by doing this, it is possible to set the batch size to more than the number of physical hardware processors. Meanwhile, the computing system 100 may include a processor and a storage device.

The processor may refer to a computing device capable of running a program for implementing the technical idea of the present disclosure, and may perform a neural network training method defined by the program and the technical idea of the present disclosure. The processor may include a single-core CPU or a multi-core CPU. The storage device may refer to a data storage means capable of storing programs and various data necessary to implement the technical idea of the present disclosure, and may be implemented as a plurality of storage means depending on the implementation example. In addition, the storage device may mean not only the main memory device included in the computing system 100, but also a temporary storage device or memory that may be included in the processor. The memory may include high-speed random access memory and may also include non-volatile memory, such as one or more magnetic disk storage devices, flash memory devices, or other non-volatile solid-state memory devices. Access to memory by processors and other components may be controlled by a memory controller.

Meanwhile, the method according to an embodiment of the present disclosure may be implemented in the form of computer-readable program instructions and stored in a computer-readable recording medium, and the control program and target program according to an embodiment of the present disclosure may also be stored in a computer-readable recording medium. Computer-readable recording media include all types of recording devices that store data that may be read by a computer system.

Program instructions recorded on the recording medium may be those specifically designed and configured for the present disclosure, or may be known and available to those skilled in the software field.

Examples of computer-readable recording media include magnetic media such as hard disks, floppy disks, and magnetic tapes, optical media such as CD-ROMs and DVDs, magneto-optical media, such as floptical disks, and hardware devices specifically configured to store and perform program instructions, such as ROM, RAM, flash memory, etc. In addition, computer-readable recording media may be distributed across computer systems connected to a network, so that computer-readable code may be stored and executed in a distributed manner.

Examples of program instructions include not only machine code such as that created by a compiler, but also high-level language code that may be executed by a device that electronically processes information using an interpreter, for example, a computer.

The hardware devices described above may be configured to operate as one or more software modules to perform the operations of the present disclosure, and vice versa.

The description of the present disclosure described above is for illustrative purposes, and those skilled in the art will understand that the present disclosure may be easily modified into other specific forms without changing the technical idea or essential features of the present disclosure. Therefore, the embodiments described above should be understood in all respects as illustrative and not restrictive. For example, each component described as unitary may be implemented in a distributed manner, and similarly, components described as distributed may also be implemented in a combined form.

The scope of the present disclosure is indicated by the claims described below rather than the detailed description above, and all changes or modified forms derived from the meaning and scope of the claims and their equivalent concepts should be construed as being included in the scope of the present disclosure.

### INDUSTRIAL APPLICABILITY

The present disclosure may be used in a method for determining an action of a bot automatically playing a champion within a battlefield of a League of Legends game, and a computing system for performing the same.

1. A computing system for determining an action of a bot automatically playing a champion within a battlefield of League of Legends (LoL) which is a computer game for e-sports, the computing system comprising:
an acquisition module configured to acquire observation data observable in the computer game periodically at every predetermined observation unit time while a game is in progress in the battlefield of the computer game;
an agent module configured to, when the acquisition module acquires the observation data, determine an action to be executed by the bot using the acquired observation data and a predetermined policy network, wherein the policy network is a deep neural network that outputs a probability of each of a plurality of executable actions that the bot is able to execute; and
a training module configured to train the policy network periodically at every predetermined training unit time while the game is in progress in the battlefield,
wherein the agent module is configured to, when observation data s(t) is acquired at a t-th observation unit time,
preprocess the observation data s(t) to generate input data,
acquire a probability of each of the plurality of executable actions that the champion played by the bot is able to execute by inputting the generated input data to the policy network,
determine an action a(t) to be executed next by the champion played by the bot based on the probability of each of the plurality of executable actions,
deliver the action a(t) to the bot so that the champion played by the bot executes the action a(t),
calculate a reward value r(t) based on observation data s(t+1) acquired at the next unit observation time after the action a(t) is executed, and
store training data comprising the observation data s(t), the action a(t), and the reward value r(t) in a buffer, and
wherein the training module is configured to train the policy network using multiple batches including a predetermined number of most recently stored training data among the training data stored in the buffer.

2. The computing system of claim 1, wherein the acquisition module is configured to acquire:
game unit data including an observation value of each of champions, minions, structures, installations, and neutral monsters existing in the battlefield; and
the observation data including a screen image of the bot playing on the battlefield.

3. The computing system of claim 2, wherein the game unit data includes:
game server-provided data which is acquirable through an API provided by a game server of the computer game; and
self-analysis data which is acquirable by analyzing data output by a game client of the bot.

4. The computing system of claim 3, wherein the agent module is configured to, in order to preprocess the observation data s(t) to generate the input data,
input the game server-provided data included in the observation data s(t) into a fully connected layer,
input the self-analysis data included in the observation data s(t) into a network structure in which a fully connected layer and an activation layer are connected in series,
input the screen image of the bot included in the observation data s(t) into a convolution layer, and
generate the input data by encoding data output from each layer in a predetermined manner.

5. The computing system of claim 1, wherein the agent module is configured to, in order to calculate the reward value r(t),
based on the observation data s(t+1), calculate an item value of each of N predefined solo items and M predefined team items (here, N and M are integers of 2 or more, and each of the N solo items and M team items is given a predetermined reward weight), and
calculate the reward value r(t) using [Equation 1] or [Equation 2] below, wherein psᵢ and pt are values given by [Equation 3] below, αⱼ is a reward coefficient of a jth solo item, pᵢⱼ is an item value of a jth solo item of an ith champion belonging to a friendly team, βⱼ is a reward weight of a jth team item, qⱼ is an item value of a jth team item of the friendly team, K is a total number of friendly champions, w is a team coefficient which is a real number satisfying 0<=w<=1, c is a real number satisfying 0<c<1, and T is a period coefficient which is a predetermined positive real number.
$$r ( t ) = ( 1 - w ) {\sum }_{i = 1}^{K} ( {ps}_{i} \times {c}^{t / T} ) + w \times \frac{pt \times {c}^{t / T}}{K} \qquad [ Equation 1 ]$$
$$r ( t ) = ( 1 - w ) {\sum }_{i = 1}^{K} ( {ps}_{i} \times {c}^{t / T} ) + w \times pt \times {c}^{t / T} \qquad [ Equation 2 ]$$
$${ps}_{i} = {\sum }_{j = 1}^{N} ( {α}_{j} \times {p}_{ij} ) \qquad [ Equation 3 ]$$
$$pt = {\sum }_{j = 1}^{M} ( {β}_{j} \times {q}_{j} )$$

6. The computing system of claim 1, wherein the computing system is configured to acquire, from a game server generating battlefield instances of the computer game in parallel, observation data corresponding to each of the plurality of battlefield instances, determine in parallel actions to be executed by bots playing on the plurality of battlefields, and train the policy network.

7. A method for determining an action of a bot automatically playing a champion within a battlefield of League of Legends (LoL) which a computer game for e-sports, the method comprising:
an acquisition operation of acquiring, by a computing system, observation data observable in the computer game periodically at every predetermined observation unit time while a game is in progress in the battlefield of the computer game;
a control operation of, when the observation data is acquired in the acquisition operation, determining, by the computing system, an action to be executed by the bot using the acquired observation data and a predetermined policy network, wherein the policy network is a deep neural network that outputs a probability of each of a plurality of executable actions that the bot is able to execute; and
a training operation of training, by the computing system, the policy network periodically at every predetermined training unit time while the game is in progress in the battlefield,
wherein the control operation comprises, when observation data s(t) is acquired at a t-th observation unit time:
preprocessing the observation data s(t) to generate input data;
acquiring a probability of each of the plurality of executable actions that the champion played by the bot is able to execute by inputting the generated input data to the policy network;
determining an action a(t) to be executed next by the champion played by the bot based on the probability of each of the plurality of executable actions;
delivering the action a(t) to the bot so that the champion played by the bot executes the action a(t);
calculating a reward value r(t) based on observation data s(t+1) acquired at the next unit observation time after the action a(t) is executed; and
storing training data comprising the observation data s(t), the action a(t), and the reward value r(t) in a buffer, and
wherein the training operation comprises training the policy network using multiple batches including a predetermined number of most recently stored training data among the training data stored in the buffer.

8. The method of claim 7, wherein the observation data includes:
game unit data including an observation value of each of champions, minions, structures, installations, and neutral monsters existing in the battlefield; and
a screen image of the bot playing on the battlefield.

9. The method of claim 8, wherein the game unit data includes:
game server-provided data which is acquirable through an API provided by a game server of the computer game; and
self-analysis data which is acquirable by analyzing data output by a game client of the bot.

10. The method of claim 9, wherein the preprocessing of the observation data s(t) to generate the input data comprises:
inputting the game server-provided data included in the observation data s(t) into a fully connected layer;
inputting the self-analysis data included in the observation data s(t) into a network structure in which a fully connected layer and an activation layer are connected in series;
inputting the screen image of the bot included in the observation data s(t) into a convolution layer; and
generating the input data by encoding data output from each layer in a predetermined manner.

11. The method of claim 7, wherein the calculating of the reward value r(t) comprises:
based on the observation data s(t+1), calculating an item value of each of N predefined solo items and M predefined team items (here, N and M are integers of 2 or more, and each of the N solo items and M team items is given a predetermined reward weight); and
calculating the reward value r(t) using [Equation 1] or [Equation 2] below,
wherein psᵢ and pt are values given by [Equation 3] below, αⱼ is a reward coefficient of a jth solo item, pᵢⱼ is an item value of a jth solo item of an ith champion belonging to a friendly team, βⱼ is a reward weight of a jth team item, qⱼ is an item value of a jth team item of the friendly team, K is a total number of friendly champions, w is a team coefficient which is a real number satisfying 0<=w<=1, c is a real number satisfying 0<c<1, and T is a period coefficient which is a predetermined positive real number.
$$r ( t ) = ( 1 - w ) {\sum }_{i = 1}^{K} ( {ps}_{i} \times {c}^{t / T} ) + w \times \frac{pt \times {c}^{t / T}}{K} \qquad [ Equation 1 ]$$
$$r ( t ) = ( 1 - w ) {\sum }_{i = 1}^{K} ( {ps}_{i} \times {c}^{t / T} ) + w \times pt \times {c}^{t / T} \qquad [ Equation 2 ]$$
$${ps}_{i} = {\sum }_{j = 1}^{N} ( {α}_{j} \times {p}_{ij} ) \qquad [ Equation 3 ]$$
$$pt = {\sum }_{j = 1}^{M} ( {β}_{j} \times {q}_{j} )$$

12. The method of claim 7, wherein the computing system is configured to acquire, from a game server generating battlefield instances of the computer game in parallel, observation data corresponding to each of the plurality of battlefield instances, determine in parallel actions to be executed by bots playing on the plurality of battlefields, and train the policy network.

13. A computer program installed in a data processing device and recorded on a non-transitory medium for performing the method of claim 7.

14. A non-transitory computer-readable recording medium on which a computer program for performing the method of claim 7 is recorded.

15. A computing system comprising:
a processor; and
a memory,
wherein the memory is configured to, when performed by the processor, cause the computing system to perform the method of claim 7.
